(19) United States
(12) Patent Application Publication
(10) Pub. No.: US 2026/0362118 A1
(43) Pub. Date: Nov. 12, 2026

(54) METHODS AND APPARATUSES FOR RADIO CAPABILITY SIGNALING OPTIMIZATION

(71) Applicant: InterDigital Patent Holdings, Inc., Wilmington, DE (US)

(72) Inventors: Taimoor Abbas, Sainte-Julie (CA); Saad Ahmad, Montreal (CA); Michael Starsinic, Newtown, PA (US); Anuj Sethi, Ottawa (CA); Ulises Olvera-Hemandez, Saint-Lazare (CA); Achref Methenni, Montreal (CA)

(73) Assignee: InterDigital Patent Holdings, Inc., Wilmington, DE (US)

(21) Appl. No.: 19/202,964

(22) Filed: May 8, 2025

(51) Int. Cl. H04W 8/22; H04W 60/04; H04W 76/20; H04W 84/04

(52) U.S. Cl. CPC H04W 8/22; H04W 60/04; H04W 76/20; H04W 84/042

(57) ABSTRACT

One or more devices, methods, and/or systems facilitate wireless transmit/receive unit (WTRU) radio capability exchange. In one example, a message may be sent from the WTRU that only contains WTRU radio capability information that has changed since the last time that the WTRU radio capability was reported. In one example, a WTRU radio capability update message may be sent over a data plane. In one example, a WTRU may send a minimal WTRU radio capability message that limits the capabilities to relevant RATs, frequency bands, cell/PLMN/country, etc.

### BACKGROUND

In large wireless communications networks, it may be important for a controlling entity, such as a node of a network, to know what a device that wants to connect to the network is capable of. Specifically, the network may need to know what the radio capabilities are. Accordingly, there is a need to optimize this exchange of information between the relevant entities within a wireless communication network.

### SUMMARY

One or more devices, methods, and/or systems facilitate wireless transmit/receive unit (WTRU) radio capability exchange. In one example, a message may be sent from the WTRU that only contains WTRU radio capability information that has changed since the last time that the WTRU radio capability was reported. In one example, a WTRU radio capability update message may be sent over a data plane. In one example, a WTRU may send a minimal WTRU radio capability message that limits the capabilities to relevant RATs, frequency bands, cell/PLMN/country, etc.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a 5G communication system architecture.

FIG. 3 illustrates an example of a 5G control plane stack between a WTRU and AMF.

FIG. 4 illustrates an example of WTRU Radio Capability ID.

FIG. 5 illustrates an example of a network architecture with a UCMF.

FIG. 7 illustrates an example procedure for WTRU initiated radio capability updates.

FIG. 8 illustrates an example procedure for WTRU radio capability exchange over the data plane.

FIG. 9 illustrates an example of a WTRU sending radio capability information.

### DETAILED DESCRIPTION

As described herein, there are one or more methods and devices that provide enhancements to the WTRU Radio Capability handling procedure for next generation wireless systems. The proposed enhancements may be represented in one or more procedures that optimizes the WTRU Radio Access Capability signaling. One or more of these procedures may remove the need to send full radio capability information, if only some of the WTRU capabilities are updated/changed on a WTRU (e.g., due to a software update).

In 5G, when the WTRU's Radio Capability Information changes (e.g., some new capabilities are added or some old capabilities are disabled due to software update, etc.), the WTRU performs the Registration procedure by sending a Registration Request message to the AMF with the Registration type set to Mobility Registration Update, including "WTRU Radio Capability Update", which relies on the full WTRU radio capability information exchange, which is inefficient and resource-consuming.

In addition to improving the existing paging procedure, one or more additional approaches regarding the handling or use of WTRU Radio Capabilities as described herein.

For example, there may be WTRU initiated procedure defined to send WTRU radio capability update, which proposes that the WTRU may report only the changed (e.g., delta) capabilities, and may do that without the need to perform registration procedure again.

For example, if the WTRU and the network are capable of data plane establishment, which is responsible for carrying the data between the WTRU and core network functions (NFs), then the WTRU upon the reception of a request from the network via RAN “RRC: WTRU Capability Enquiry” and an indication that indicates the transport of WTRU radio capability over data plane is supported, would send the WTRU radio capability to the NFs (UCMF, AMF) over the data plane.

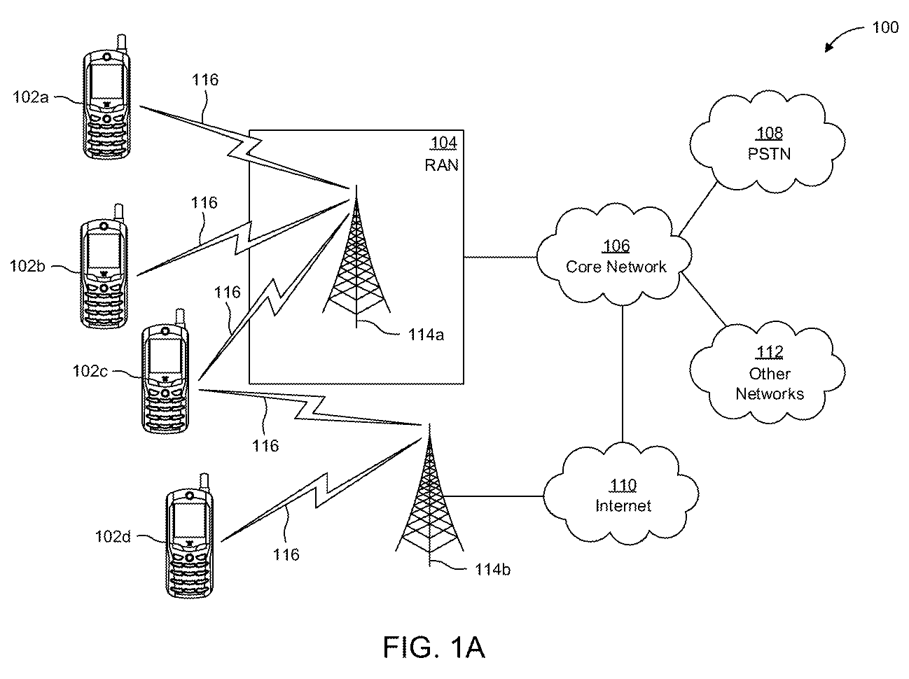

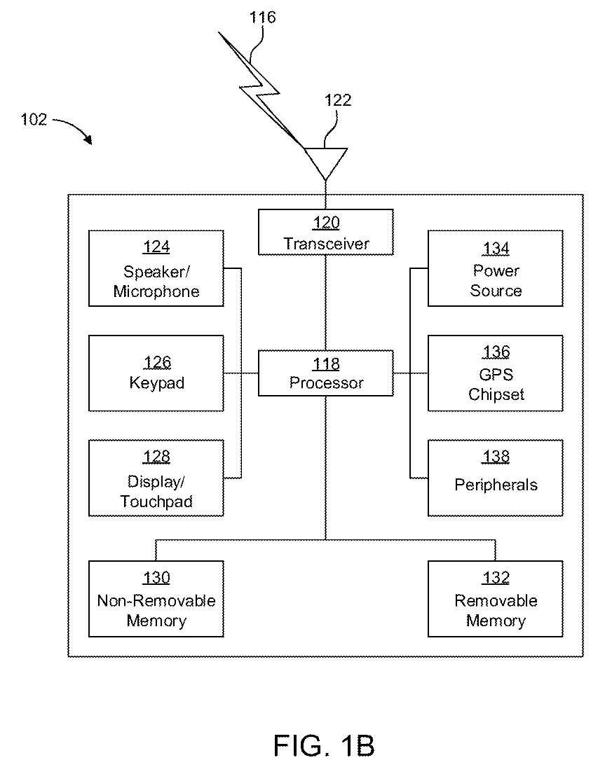

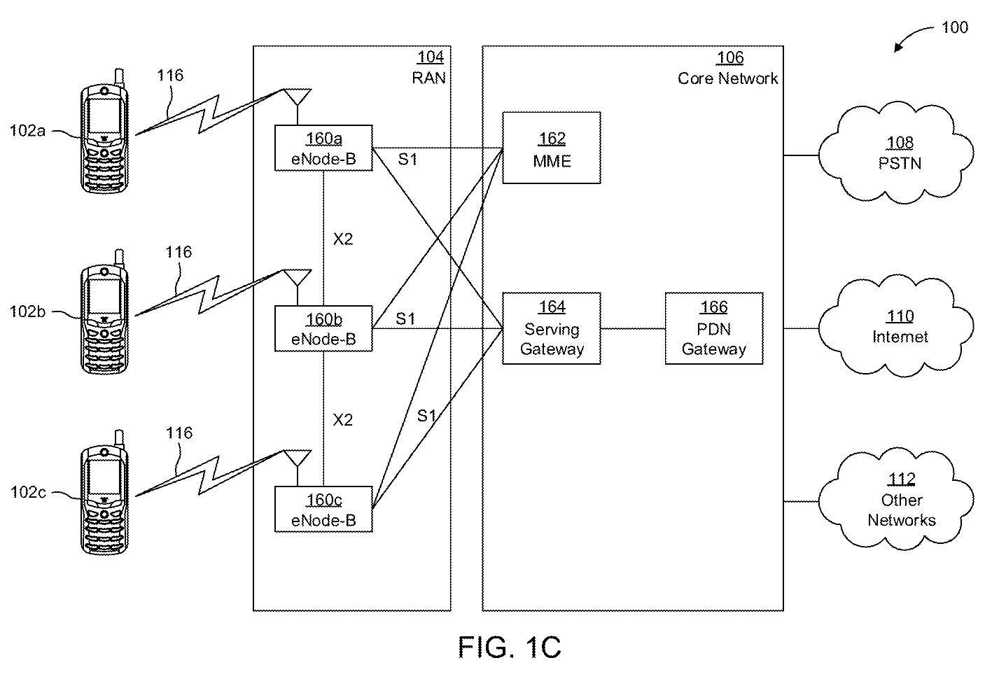

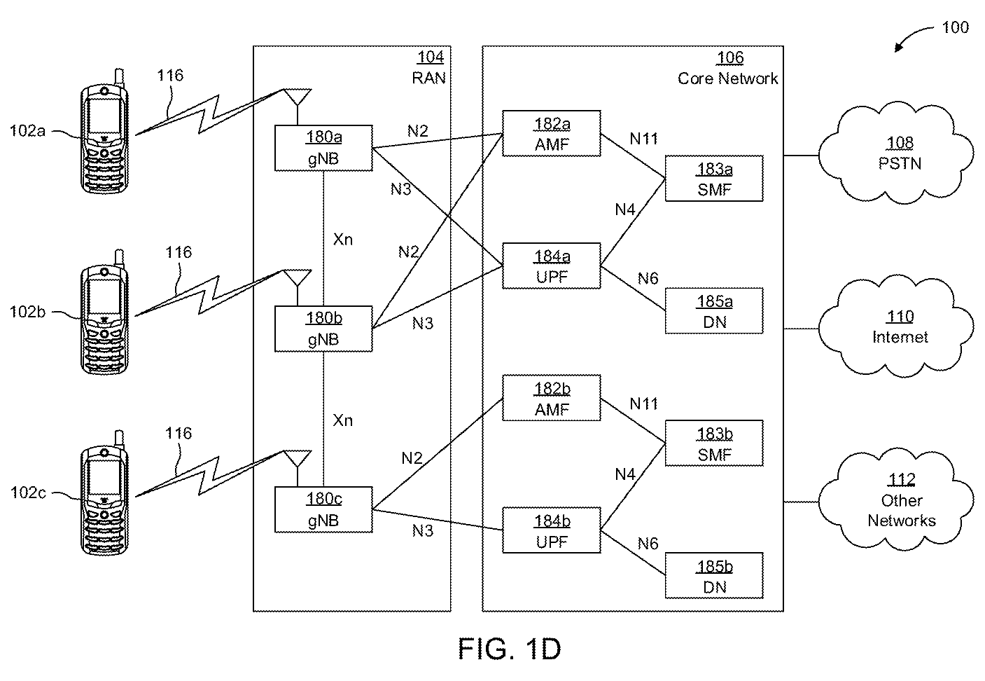

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102cwith access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102cwith access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180cmay implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180cmay implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b(and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102cmay communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180cas a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182bin the CN 106 via an N11 interface. The SMF 183a, 183bmay also be connected to a UPF 184a, 184bin the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

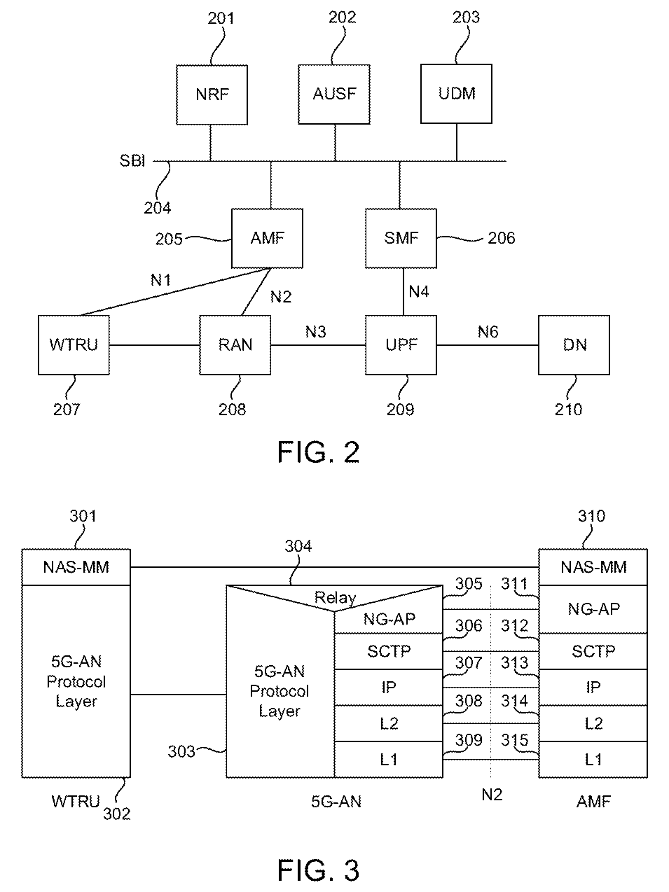

FIG. 2 illustrates an example of a 5G communication system architecture. As illustrated, only a subset of the Network Functions (NFs) in the 5G Core are represented: NRF 201, AUSF 202, UDM 203, AMF 204, SMF 205, WTRU 206, RAN 207, UPF 208, DN 209. One or more NFs (e.g., AMF, SMF, UDM) may communicate with each other using a Service Based Interface (SBI) (using protocols like HTTP). The Service Base Architecture (SBA) (e.g., utilizing SBI) may enable NFs to expose services (e.g., using RESTful APIs, etc.) to other NFs, for the system to provide a desired functionality.

The other interfaces shown (e.g., Nx), described herein, are different from SBI. For example, a WTRU may communicate with the AMF over N1 using a NAS protocol. Control plane messaging between the WTRU and other NFs (e.g., SMF) may be performed using NAS transport encapsulation mechanism provided by AMF for the NFs. The RAN may communicate over the network using N2.

In the illustrated example of the 5G architecture, there may be a WTRU at the end of the network, which includes devices like UEs, smartphones, IoT devices, etc. that initiate and receive communication. The WTRU may connect to the Radio Access Network (RAN), which handles the wireless communication and acts as a bridge between the WTRU and the core network (CN). The RAN interfaces with the Access and Mobility Management Function (AMF) through the N2 interface for control signaling, while the WTRU also connects directly to the AMF via the N1 interface for registration and authentication-related messages.

The AMF’s functions include managing access, mobility, and signaling with the WTRU, as well as interacting with other core components via the Service-Based Interface (SBI). The NFs may include the Session Management Function (SMF), which is responsible for session establishment, IP address allocation, and traffic routing decisions. The SMF, in turn, may interact with the User Plane Function (UPF) through the N4 interface to configure data forwarding paths. The UPF is responsible for handling user data traffic and connects to external Data Networks (DN), such as the internet or enterprise networks, through the N6 interface.

Additionally, the AMF interacts with several key service functions over the SBI. These nodes include the Network Repository Function (NRF), which maintains a registry of available network functions and their capabilities; the Authentication Server Function (AUSF), which authenticates the WTRU; and the Unified Data Management (UDM), which manages subscriber information and profiles. The RAN also connects directly to the UPF via the N3 interface to enable efficient transmission of user data.

In some cases, there may be a next-generation wireless architecture (e.g., beyond 5G, such as 6G, or #G) where more components of the system may utilize service-based communication. For example, the WTRU may utilize an SBI to connect with different components of the system. In one instance, the WTRU may connect directly with the RAN. In one instance, the WTRU may operate without an AMF and instead utilize protocols as part of the SBI architecture.

While some procedures and/or examples described herein reference 4G and/or 5G aspects, it may be understood that these are for demonstration purposes only, and it is intended that the underlying techniques described herein are applicable to next-generation systems as well. For example, if an example or procedure discusses utilizing a 5G architecture, then it is intended that the example or procedure is applicable to a next-gen architecture as well, with appropriate differences as applicable. For example, if a procedure or example described herein describes a WTRU interacting with an AMF through an N2 interface, then it is intended that that example or procedure may apply to another architecture where an SBI is utilized to communicate with an AMF, or to interact directly with another NF using an SBI and not using an AMF.

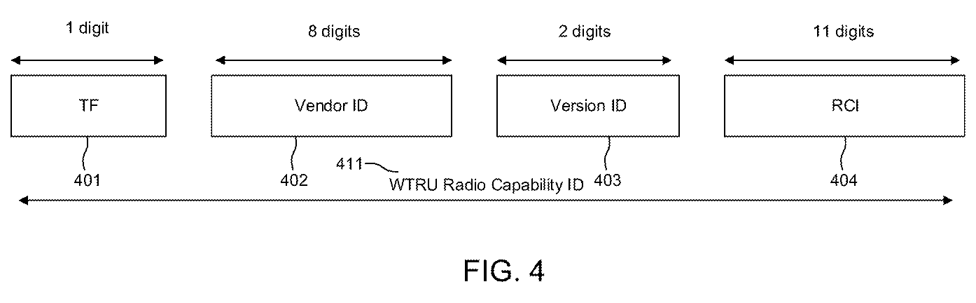

FIG. 3 illustrates an example of a 5G control plane stack between a WTRU and AMF. As illustrated, the RAN may communicate with the AMF over N2 using an NGAP protocol. Control plane messaging between the WTRU and RAN (Access Stratum (AS)) may be performed using RRC (e.g., top of the 5G-AN Protocol layers) that may be used to transport NAS messages received or sent by RAN over N2.

In some cases, WTRU radio capability information may be stored in the AMF or another NF.

The WTRU Radio Capability information may include details on the Radio Access Technologies (RATs) supported by a WTRU, such as power class and frequency bands. This information may be stored by the Access and Mobility Management Function (AMF), such as during a CM-IDLE and RM-REGISTERED states. This storage may help avoid the overhead of sending this information across the radio interface during state transitions. The AMF may delete the stored information when the WTRU transitions to the RM-DEREGISTERED state or during specific registration requests.

When the WTRU’s radio capability changes while in the CM-IDLE state, the WTRU may perform a Mobility Registration Update, prompting the AMF to delete any previously stored capability information. The Radio Access Network (RAN) may store the WTRU Radio Capability information while the WTRU is in the RRC_CONNECTED or RRC_INACTIVE state.

For WTRUs that support both NB-IoT and other RATs, the AMF may handle the radio capabilities distinctly. When the WTRU is camping on NB-IoT, it may provide only NB-IoT capabilities to the network, and the AMF may store this information separately. When the WTRU is not camping on NB-IoT, it provides capabilities for other RATs, and the AMF sends the appropriate capabilities based on the WTRU's current camping status.

In some cases, there may be one or more approaches for WTRU radio capability signaling optimization (RACS).

With the increasing size of WTRU radio capabilities (e.g., due to additional frequency bands and combinations for E-UTRA and NR, etc.), the Radio Access Capability Signaling (RACS) approach may efficiently signal WTRU Radio Capability Information over the radio and network interfaces. For example, RACS may assign a WTRU Radio Capability ID to represent a set of WTRU radio capabilities, which can be either manufacturer-assigned or network-assigned.

For manufacturer-assigned, the WTRU manufacturer assigns the ID, which includes a Vendor ID. This ID uniquely identifies a set of WTRU radio capabilities for the WTRU across any network.

For network-assigned, the UE (e.g., WTRU) Capability Management Function (UCMF) may allocate IDs. For example, the UCMF may allocate IDs for different sets of WTRU radio capabilities received at different times. These IDs may be specific to the serving network and include a Version ID to indicate whether the ID is current or outdated. In one instance, if the manufacturer-assigned ID is not used by the network's WTRU, the UCMF may then assign an ID. In one instance, if the manufacturer-assigned ID is not recognized by the network's WTRU, the UCMF may then assign an ID. In one instance, the network-assigned WTRU Radio Capability ID may be allocated using the WTRU Configuration Update Command or Registration Accept. The UCMF, or other NF, may store all mappings of WTRU Radio Capability IDs within a given network (e.g., Public Land Mobile Network (PLMN) of a provider, etc.) and may be responsible for assigning these IDs. The UCMF, or other NF, may also store the WTRU Radio Capability information and its mapped WTRU Radio Capability for Paging (e.g., such mapping may be utilized in a paging process).

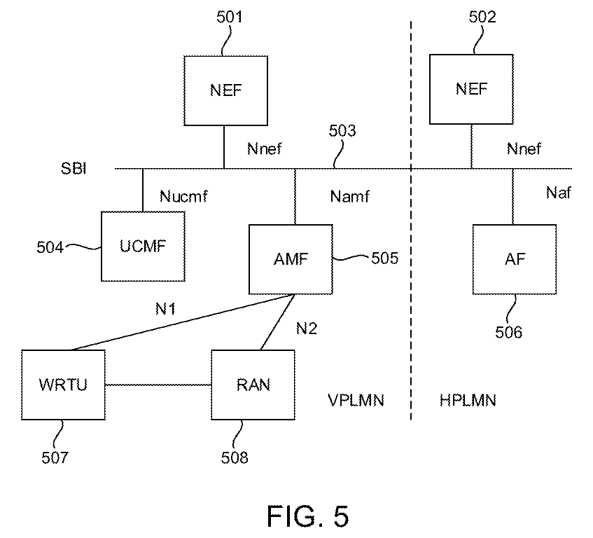

FIG. 4 illustrates an example of WTRU Radio Capability ID. In this example, the WTRU Radio Capability ID format is illustrated, which may be signaled by the WTRU in NAS signaling (e.g., 6G, 5GC, or EPS specific).

As shown in FIG. 4, there may be a Type Field (TF) 401 that is 1 digit, a Vendor ID 402 that is 8 digits, a Version ID 403 that is 2 digits, and/or a Radio Configuration Identifier (RCI) 404 that is 11 digits. The number of digits shown in the illustration is merely an example and may be greater or less than illustrated.

The TF - Type Field (TF) identifies the type of WTRU radio capability ID. For example, Type = 0 may mean a manufacturer-assigned WTRU radio capability ID. For example, Type = 1 may mean network-assigned WTRU radio capability ID.

The Vendor ID is an identifier of the WTRU manufacturer and is only present if TF = 0. The vendor IDs may be provided by the Internet Assigned Numbers Authority (IANA). The complete list of assigned numbers is publicly available on IANA’s website. In some cases, the vendor ID may not be included, not illustrated, in situations where the capability ID was network-assigned (e.g., as described herein).

The Version ID is configured by the UE Capability Management Function (UCMF) that is part of the core network (e.g., EPS, 5GC, 6GC, etc.). The Version ID value makes it possible to detect whether a WTRU Radio Capability ID is current or outdated.

The Radio Configuration Identifier (RCI) identifies the WTRU radio configuration.

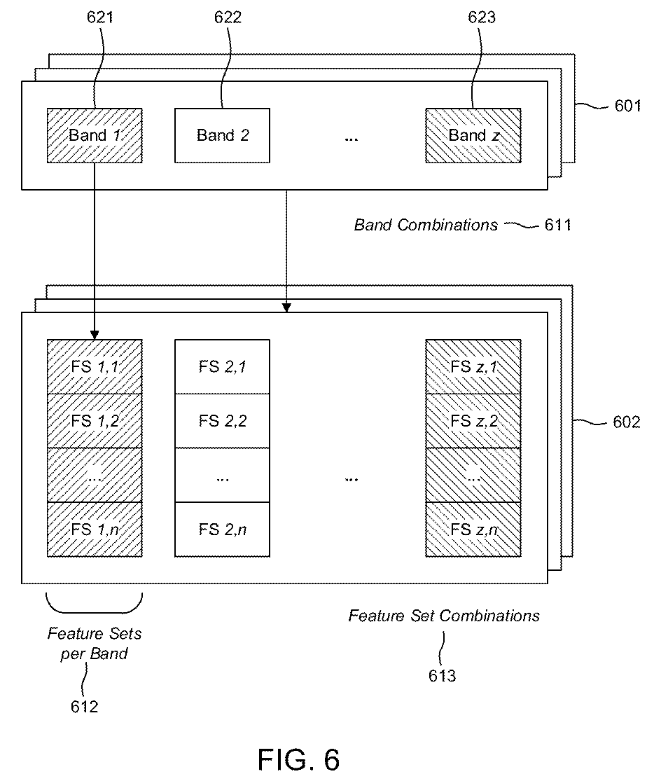

FIG. 5 illustrates an example of a network architecture with a UE (e.g., WTRU) Capability Management Function (UCMF). As shown, in the Visited PLMN (VPLMN) 500 there is a NEF 501, UCMF 502, AMF 503, WTRU 504, RAN 505; in the Home PLMN (HPLMN) 510 there is a NEF 511 and an AF 512. As shown, the WTRU may signal with the network (e.g., to a base station part of the RAN such as gNB). The RAN may then relay signaling to the AMF over the N2 interface. The UCMF may serve as an anchor with the core responsibility of management of WTRU radio capabilities, assignment of WTRU radio capability IDs, and enabling efficient, on-demand access to this data across the 5G core to support mobility, session setup, and optimization. The AMF may interact with the UCMF via the Nucmf interface, requesting or updating WTRU radio capability information as needed. For example, when the WTRU registers in the VPLMN, moves between cells, or requires policy enforcement.

In one instance, the UCMF in the core network may store and manage the WTRU capability IDs (e.g., along with context and other information about the WTRU). The UCMF may handle the storage of dictionary entries for both network-assigned and manufacturer-assigned IDs, assign network-assigned ID values, and/or provision manufacturer-assigned ID entries through interactions with the AF, either directly or via NEF/SCEF or Network Management. In one instance, the WTRU may use the UCMF of the particular PLMN in which it is camping (e.g., as shown in FIG. 5, the WTRU is in the VPLMN, therefore it uses the UCMF that is there).

FIG. 6 illustrates an example of a feature set combination. As shown, there are frequency bands shown at 601, such as band 1 621, band 2, 622, and band z at 623. These represent the various radio frequency bands supported by the network, which can be used individually or in combination (e.g., band combinations 611) to enable features like carrier aggregation and dual connectivity.

In some instances, for some features in intra-band contiguous CA (Carrier Aggregation), the WTRU may report its capabilities individually per carrier. Those capability parameters may be sent in a feature set per component carrier, and they may be signaled in the corresponding FSs (e.g., per Band) (e.g., for the corresponding block of contiguous serving cells in a band). The capability applied to each individual carrier in a block may be agnostic to the order in which they are signaled in the corresponding FS. To limit signaling overhead, the base station may request the WTRU to provide NR capabilities for a restricted set of bands.

As shown, each band may be associated with multiple feature sets (e.g., feature sets for each band 602), such as the feature sets (e.g., FS₁,₁, FS₁,₂, ..., FS₁,ₙ) for Band 1 612, and similarly for the other bands. A feature set may be a specific group of capabilities for that band. These combinations (e.g., feature set combinations 613) may define the aggregate capabilities of a WTRU when it operates across multiple bands simultaneously. For example, a WTRU might support a combination that includes FS₁,₁ from Band 1, FS₂,₂ from Band 2, and FSz,₃ from Band z, thereby communicating to the network which capabilities it can support when those bands are used together. This approach allows the network to optimize spectrum use and scheduling by selecting configurations that match the device's declared capabilities.

As may be understood, there is room for further optimization, as there may be better management of the amount of signaling that needs to be sent, since there is no need to signal information for bands the WTRU is not using in some circumstances where legacy approaches would send for all bands (e.g., even the ones that the WTRU is not using).

Generally, a cellular network needs to understand what the WTRU is capable of (e.g., receiving capability information) to understand what features and configurations are supported by the device (e.g., WTRU). The WTRU Radio Capabilities provide the network with information about, for example, the WTRU’s supported bands and combinations for E-UTRA and/or NR. With the evolution of technology standards, some devices may support a wide range of bands, multiple RATs (e.g., NR, E-UTRA, sometimes legacy GSM/UMTS, etc.), carrier aggregation combinations, MIMO layers, and/or other features, which makes the WTRU radio capability messages very large. The size of a WTRU radio capability message may further grow with the introduction of next-generation (e.g., 6G) cellular systems. In addition, the WTRU may not be using all bands, or some WTRU features may only be supported in a restricted set of bands. Therefore, an efficient approach to signal WTRU radio capability information is needed for future generations of mobile communication systems. Accordingly, there is a need for one or more approaches to enable WTRU radio capability updates in an optimal way, such as without sending the whole set of WTRU radio capabilities.

Some network functions or services may require full-capability information exchange, such as during the idle mode transitions, which may lead to excessive signaling load when the size of the WTRU radio capability information is large, especially when it is sent via RRC messaging. Accordingly, there is a need for multiple ways of transporting the WTRU radio capability information from the WTRU to the network. In some cases, a system may benefit from an alternative transport method (e.g., other than RRC) to transport WTRU radio capability information from the WTRU to the network.

As described herein, there may be one or more methods and/or devices that address how and what needs to be done to ensure an efficient way of exchanging WTRU radio capabilities between a device and network functions for the next generation of wireless networks.

As described herein, there may be approaches with respect to handling WTRU Radio Capability for wireless systems (e.g., 4G, 5G, 6G, etc.). WTRU Radio Capability handling procedures may refer to procedures that are used to convey information about the WTRU’s radio capabilities to the network. Approaches described herein may optimize the WTRU Radio Access Capability signaling by removing the need to send full radio capability information, if only some of the WTRU capabilities are updated on the WTRU (e.g., due to a software update).

Currently in 5G, when the WTRU's Radio Capability Information changes (e.g., some new capabilities are added or some old capabilities are disabled due to a software update), the WTRU performs a registration procedure by sending a registration request message to an AMF with the registration type set to “Mobility Registration Update”, including a "WTRU Radio Capability Update" information element. This message may rely on the full WTRU radio capability information exchange, which is inefficient and resource-consuming.

For one or more cases described herein, it may be assumed that Radio Access Capability Signaling (RACS) is supported (e.g., by both the WTRU and network). RACS may be used to efficiently signal WTRU Radio Capability Information over the radio and network interfaces. In a RACS procedure, a WTRU Radio Capability ID may be assigned to represent a set of WTRU radio capabilities, which may be either manufacturer-assigned or PLMN-assigned (e.g., as described herein). Accordingly, in some instances, only the ID may need to be sent, thereby reducing overhead, but the ID may only be sent once the full set of capabilities of the WTRU is understood by both the WTRU and the network.

For one or more cases described herein, it may be assumed that a data plane connection between the WTRU and the network functions is supported. The data plane connection is responsible for carrying data between the WTRU and NFs while the data generator/consumer is within the network domain (e.g., WTRU or the NF), and it never leaves the operators’ network.

A RAN node may support a service-based interface (SBI) towards a Core Network (CN) (e.g., next-gen or legacy), which acts as an SBI gateway between a WTRU and the CN. As described herein, the RAN node may be interchangeably referred to as base station, next generation NB/gNB, gNB, eNB, or intelligent NB.

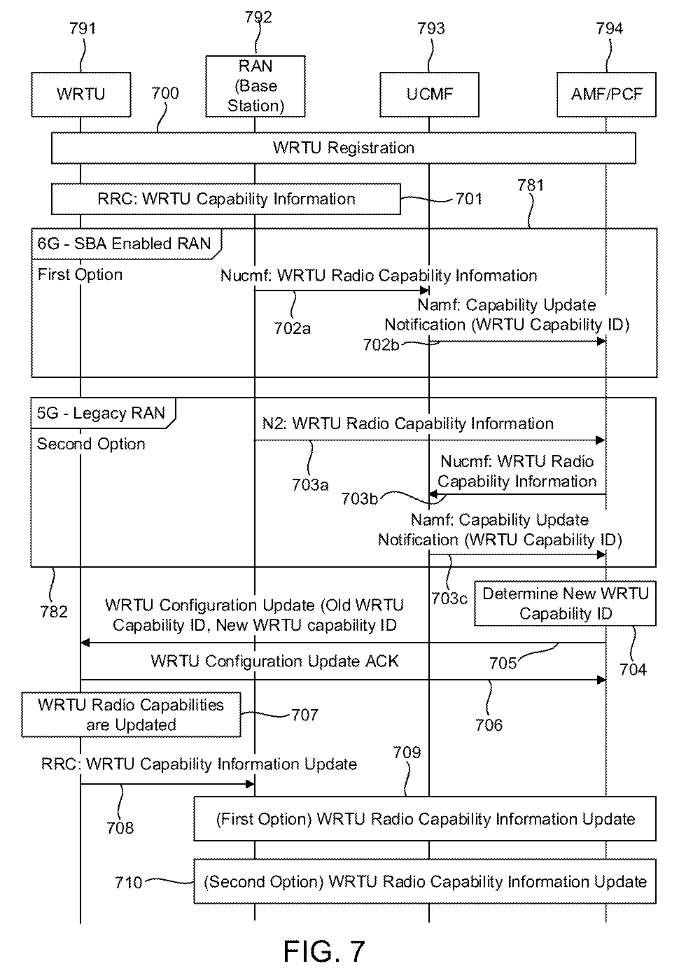

FIG. 7 illustrates an example procedure for WTRU initiated radio capability updates. In this example there may be a WTRU initiated procedure to send a WTRU radio capability update, where the WTRU may report only the changed (e.g., “delta”) capability values, and may send the report without the need to perform a registration procedure again.

As shown, there may be one or more entities involved in the procedure, such as a WTRU 791, a RAN node 792 (e.g., base station, Ng-gNB, etc.), a UCMF 793, and/or an AMF/PCF 794.

At 700, the WTRU may initiate registration. Initiating registration may include the WTRU sending a registration request to the network (e.g., an AMF). The registration request, or a subsequent message, may include a minimal set of the WTRU radio capabilities.

The minimal set of WTRU radio capabilities may be a simplified/reduced/lightweight/etc. indication of WTRU capabilities that helps the network make initial decisions, efficiently, such as cell selection/reselection, initial resource assignment, paging, etc. Later, the network (e.g., NF, AMF, etc.) may decide to request full capability information from the WTRU; then the network may send a message to the WTRU (e.g., WTRU capability inquiry message, WTRU capability request message, etc.) via a base station (e.g., RRC signaling, or other messaging as described herein).

In one case, the minimal WTRU radio capability sent during the initial registration may be simplified by limiting the initial WTRU capability information to: a specific RAT and/or frequency band(s) supported by the camped cell/PLMN or the country (e.g., only 5G or 6G for which the WTRU is attempting the registration initially); frequency bands supported by the selected PLMN and the country; and/or, only a subset of bands where certain WTRU features are supported (e.g., for carrier aggregation, including DAPS (Dual Active Protocol Stack, Conditional PSCell Addition/Change (CPAC)). The WTRU may determine the minimal WTRU radio capabilities, then send them.

At 701, the WTRU initial registration will be completed, and the WTRU may need to send a full set of capability information. The WTRU may receive a message from the network that triggers the determination and/or sending of the full set of capability information. In one example, the message may be part of another type of message, it may be an RRC message, DCI, or other messaging described herein (e.g., RRC: WTRU capability inquiry, request, etc.). The WTRU may determine and/or send a message to the network (e.g., RAN node, etc.). The message may be an indication of the full WTRU radio capability information (e.g., the actual list of capabilities or an ID that identifies the full list of capabilities because the full capabilities are previously associated with an ID). The capabilities information may be part of another message, and/or may be an RRC message, DCI message, and/or other messaging described herein (e.g., RRC: “WTRU capability information message”).

In one instance, each time the WTRU sends the WTRU radio capabilities (e.g., minimal, full, or just change information) to the network the WTRU determines (e.g., generates, preconfigured, recalls, etc.) an ID associated with the WTRU radio capability information and send the ID along with the WTRU capability information message. For example, at time 0, The WTRU may send a full list of capability information and an ID (e.g., self-generated, pre-configured, or received, etc.), and/or an associated index. Then, at time 1: The WTRU may send the last self-generated ID, the delta (e.g., only what has changed in the capability information), a new self-generated ID, and/or an indication of what number ID this is (e.g., index).

In some instances, each time the WTRU sends the WTRU radio capabilities to the network, the WTRU may include an index (e.g., a counter, or time-stamp, etc.) with the WTRU radio capability information and send the index along in the WTRU capability information message such that a network node (e.g., RAN or UCMF) may then use this information to differentiate the most recent capability information received from the WTRU (e.g., and/or detect if there was a missed message, etc.). This index may be used by the WTRU to further communicate the delta or subset difference in the WTRU radio capability as compared to the last exchanged WTRU radio capability identified by the index.

In one instance, the ID may serve as the index. In one instance, the index may serve as the ID. In one instance, the ID may not be related to the index, and an index may not be used. In one instance, the ID and index may be interchangeable.

First Option 781 – For a first option in this example procedure (e.g., SBA enabled RAN such as 6G), it may be assumed that the RAN node supports SBI towards a (e.g., next generation SBA architecture) Core Network, hence it may communicate directly with any NF over the SBI interface.

At 702a (e.g., RAN to UCMF), if the RAN is SBI enabled, then the base station may send the WTRU radio capability information, including the WTRU-generated ID (e.g., Nucmf: WTRU radio capability information), to the UCMF directly. The ID and/or capability information may also be sent to the AMF directly (e.g., Namf: WTRU radio capability information).

At 702b (e.g., UCMF to AMF), the UCMF may generate WTRU capability ID(s) and may send them to the AMF.

In one instance, the AMF may have subscribed to the UCMF, so it may report any new or updated WTRU capability ID(s) to the AMF for the WTRU(s) that are served by the AMF. Hence, the UCMF may use a message (e.g., Nucmf_WTRUCapabilityManagement_Notify) to send WTRU radio capability ID(s) to the AMF.

Second Option 782 – For a second option (e.g., Non-SBA system such as 5G RAN), it may be assumed that the RAN node does not support SBI towards a Core Network, hence it may use an N2 interface to communicate to AMF and via AMF may communicate to other NFs.

At 703a (e.g., RAN to AMF), if the RAN does not support SBI, then the base station may send the WTRU radio capability information, including the WTRU-generated ID (e.g., N2: WTRU radio capability information) to the AMF.

At 703b (AMF to UCMF), the AMF may send the WTRU radio capability information, including the WTRU-generated ID (e.g., Nucmf: WTRU radio capability information) to the UCMF.

At 703c (UCMF to AMF), the UCMF may generate WTRU capability ID(s) and may send the ID(s) to the AMF. This may be similar to or the same as step 702b.

Third Option (not illustrated) – For a third option, (e.g., which may coexist with any combination of the first option or the second option, or operated independently of both) it may be assumed that the RAN node does not need to be involved for a capability exchange between the WTRU and the AMF, hence the WTRU may communicate directly with the AMF or some other NF to send WTRU radio capabilities via a control plane or data plane signaling.

At 704 the AMF may determine if the received WTRU capability ID is known or not (e.g., the UCMF may have assigned the full WTRU capabilities sent at 701 an ID and sent this information to the AMF; note, the UCMF may do this in an instance where the WTRU has not generated its own ID). If not known, the AMF may store it locally and may forward the WTRU capability ID to the base station. The AMF may send a reference or full capability as retrieved from the WTRU or UCMF to the base station.

At 705, the AMF may send a message, such as a registration accept message or UCU (e.g., UE/WTRU configuration update) message or some other message, to the WTRU. The message may include the WTRU capability ID (e.g., that was assigned by the UCMF) and/or may include an old WTRU capability ID (e.g., if available on the AMF).

At 706, the WTRU may send an acknowledgement (e.g., a UCU ACK).

At 707, the WTRU's radio capabilities may change. For example, the reason for the change may include one or more of the following: some new capabilities are added, some old capabilities are disabled due to software update, configuration from the GUI/MMI, enabling/disabling of certain RATs, country specific enabling/disabling of the RATs, enabling/disabling of certain RATs based on the RAT restriction information received from the network such as an Enhancement of controlling RAT utilization (ECRATU) feature, enabling/disabling of certain RATs/supported bands based on the reject cause received by the WTRU via the NAS signaling. The change in WTRU radio capabilities may trigger the WTRU to perform an update procedure (e.g., WTRU capability information update procedure, etc.).

At 708, the WTRU capability information needs to be updated. The WTRU may send an update message (e.g., RRC message or other type described herein) (e.g., WTRU capability information update message, WTRU capability update message, etc.) to the RAN node. The update message may include just the change, meaning just the difference (e.g., delta) between the parameters in the changed WTRU radio capability information and the original WTRU radio capability information. The delta may be determined by the WTRU by comparing the full WTRU radio capability information to the full WTRU radio capability after the change/update. In one instance, the delta may comprise a list of added and/or removed parameters.

For example, the difference between a first set and a second set: at time 1, the WTRU indicates that it supports X, Y and Z capabilities; at time 2, the WTRU indicates (e.g., in a message that is smaller than the indication at time 1) that it no longer supports X but now also supports A. The WTRU may do this by indicating that it does not support X and it does support A, or by indicating that it supports only A (e.g., which would implicitly indicate that it doesn’t support X with respect to that category or type). Note, that there may be more than one way to indicate only the delta. Thus, the network may be informed that A, Y and Z are supported.

In one instance, an update message sent by the WTRU (e.g., WTRU capability updates, WTRU capability information update message, etc.) may be enabled (e.g., over RRC, DCI, etc.), which is triggered upon WTRU radio capability(ies) change. For example, the WTRU may be able to send an update message with WTRU capability information, such as a delta, partial or a full set, that does not require a message from the network requesting the information, such as a WTRU capability inquiry or request.

In one instance, the update message may be a part of another type of message (e.g., any type of message described herein).

In one instance, the WTRU may initiate a registration procedure by sending a registration request message to the AMF with registration type set to Mobility Registration Update. This may be an update message, and may include the delta or a changed full set of WTRU capability information (e.g., WTRU radio capability update, WTRU radio capability information, etc.). In one instance, the message may include the delta parameters in the most efficient form.

In one instance, similar to at 701, when the WTRU sends the update message to the network, the WTRU may generate and/or include a new ID and/or index associated with the changed WTRU radio capability information (e.g., delta or full set). In one instance, the index may be incremented relative to the number of updates sent.

In one instance, if the WTRU has an associated WTRU radio capability ID, then it may include the WTRU radio capability ID (e.g., of the full set of WTRU capabilities, that was received previously (e.g., network assigned) or preconfigured (e.g., manufacture assigned)) in the update message along with the delta parameters.

In one instance, the update message may include an indication that the message is to inform the RAN that the WTRU radio capabilities have been changed. Hence, the network (e.g., including RAN, AMD, UCMF, etc.) may update the WTRU radio capability information and associated RACS ID(s).

In one instance, the update message may be limited to a change with respect to only: a specific RAT and/or frequency band(s) supported by the camped cell/PLMN or the country (e.g., only 5G or 6G for which the WTRU is attempting the registration initially); frequency bands supported by the selected PLMN and the country; and/or, only a subset of bands where certain WTRU features are supported (e.g., for carrier aggregation, including DAPS (Dual Active Protocol Stack, Conditional PSCell Addition/Change (CPAC)). For example, if a change is made to a WTRU capability, but that capability is not relevant to the connection or a future connection, the WTRU may decide not to send an update message. For example, if a change is made to a WTRU capability, and that capability is relevant to the connection or a future connection, the WTRU may decide to send an update message but only pertaining to a specific aspect of the connection (e.g., as described herein, such as RAT, frequency, etc.).

In one instance, where the WTRU generated an ID earlier in the process, the ID may be sent to the UCMF and then used by the UCMF to keep track of the updated/change capability info sent by the WTRU (e.g., 707/708), and based on the update/change the UCMF may assign a new WTRU radio capability ID and/or suggests whether or not to discard an old ID(s). The UCMF may do what is instructed by the UCMF with respect to the capability ID.

At 709 (e.g., similar/same as the first option) (e.g., similar/same as 702a/b), the update message may be sent from the RAN to the UCMF and from RAN to AMF. In one instance, the update message may include the delta parameters and/or an associated ID/index (e.g., WTRU generated IE, WTRU radio capability ID, etc.).

At 710 (e.g., similar/same as the second option) (e.g., similar/same as 703a/b/c), the update message may be sent from RAN to the AMD via N2. In one instance, the update message may include the delta parameters and/or the associate ID (e.g., WTRU generated IE, WTRU radio capability ID, etc.).

Upon reception of update message, the UCMF may generate a new WTRU radio capability ID and send it to the WTRU, similar/same as 704, 705, and/or 706.

As described herein, one or more steps or actions of FIG. 7 may be optional, reordered, and/or be combined with one or more other examples or procedures described herein.

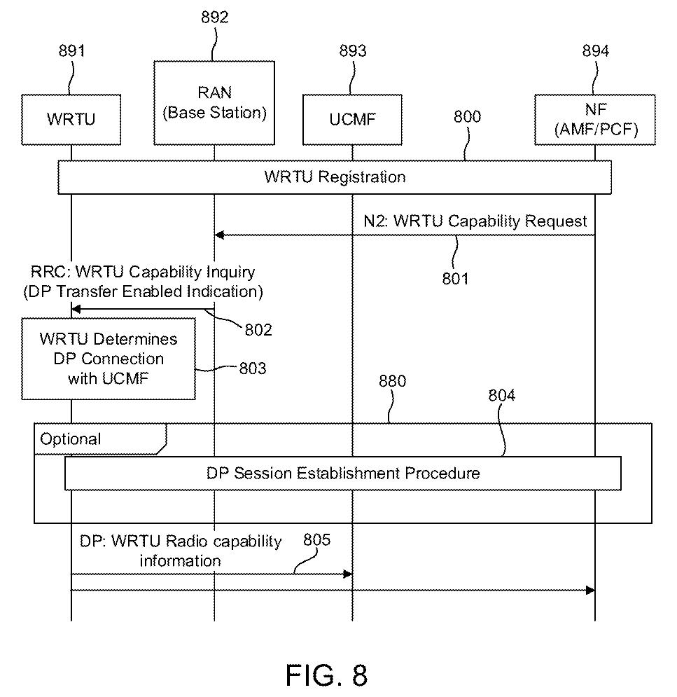

FIG. 8 illustrates an example procedure for WTRU radio capability exchange over the data plane. Generally, in this example, it may be assumed that the WTRU and the network are able to establish a data plane connection that may be used for carrying data and/or other messages between the WTRU and core network functions (NFs). Based on this connection, the WTRU may send the WTRU radio capability to the NFs (e.g., UCMF, AMF, etc.) over the data plane. The WTRU may send the WTRU capability information (e.g., full set or just a delta) based on or more scenarios. For example, the WTRU may send the capability information if there is a change of the WTRU capability information. For example, the WTRU may send the capability information based upon the reception of a request from the network (e.g., via RAN RRC WTRU capability inquiry, request, etc.”). For example, the WTRU may send the capability information if an indication that transport of WTRU radio capability over the data plane is supported (e.g., DCI, RRC, etc.).

At 800, the WTRU may initiate registration; this may be accomplished in one or more ways, such as sending a registration request to an AMF that may contain the minimal set of the WTRU radio capability information (e.g., as described herein). A minimal set of WTRU radio capability information may be a simplified indication of WTRU capabilities that helps the network make initial decisions efficiently, such as cell selection, initial resource assignment, paging, etc. Later, the network (e.g., NF, AMF, etc.) may decide to request full capability information from the WTRU; then the network may send a message to the WTRU (e.g., inquiry, request, etc.) via a base station (e.g., RRC signaling, or other messaging as described herein).

In one case, the minimal set of WTRU Radio capability information may be simplified by limiting the initial WTRU capability information to: a specific RAT and/or frequency band(s) supported by the camped cell/PLMN or the country (e.g., only 5G or 6G for which the WTRU is attempting the registration initially); frequency bands supported by the selected PLMN and the country; and/or, only a subset of bands where certain WTRU features are supported (e.g., for carrier aggregation, including DAPS (Dual Active Protocol Stack, Conditional PSCell Addition/Change (CPAC)).

In one instance, if the WTRU and the network are capable of data plane establishment, or via the user plane, which is responsible for carrying data between the WTRU and core network functions (NFs), then upon initial registration of the WTRU, the WTRU may receive configuration information with the FQDN/IP addresses of the NFs, such as UCMF, and AMF.

At 801, if the network (e.g., AMF, UCMF, etc.) decides that it needs full WTRU radio capability, then it may send a WTRU capability request to the WTRU (e.g., via the RAN node via N2 in case SBI is not supported between RAN and AMF, via service-based request if SBI is supported between RAN and AMF, and/or directly via SBI if the WTRU supports a next gen SBA architecture as described herein). The AMF may include the WTRU radio capability information it has previously received from base station or UCMF (e.g., if available).

In one instance, the WTRU capability request may include an indication that WTRU radio capability transfer via the data plane is enabled, or via user plane.

At 802, the RAN node may send a message requesting WTRU capability (e.g., inquiry, request, etc.) to the WTRU via the base station (e.g., over the RRC signaling, or other signaling described herein).

In one example, if the data plane establishment is enabled, and/or RAN receives an indication that the WTRU radio capability transfer via the data plane is enabled, then the RAN node may include an indication, or flag in the message to indicate to the WTRU that the WTRU radio capability transfer via the data plane is enabled.

In another example, the message requesting WTRU radio capability may be another type of control plane NAS message. For example, the message may be a WTRU configuration update command, paging message with new information element requesting WTRU radio capabilities, or the like.

At 803, based on the WTRU capability, and the indication that the transport of WTRU radio capability over the data plane is supported, the WTRU may determine whether the data plane is established or not.

At 804, if the WTRU determines that the data plane is not established then it may trigger data plane setup procedure.

At 805, if the data plane is established, then the WTRU sends WTRU capabilities to the NF that has requested the WTRU radio capabilities (e.g., UCMF, AMF, etc.).

As described herein, one or more steps or actions of FIG. 8 may be optional, reordered, and/or be combined with one or more other examples or procedures described herein.

In one example, a WTRU may perform a WTRU capability update procedure. The WTRU may send a first message with a full list of capabilities that it supports to the network. The WTRU may have received a WTRU radio capability ID, and used this to send the full list.

An event may take place at the WTRU that changes what radio capabilities the WTRU supports. After the change, the capabilities supported by the WTRU are not the same as the capabilities sent by the WTRU in the first message.

When the WTRU's radio capability information changes (e.g., some new capabilities are added, or some capabilities are disabled that were previously supported, etc.), the WTRU may trigger a capability information update procedure.

The WTRU may send an update message to indicate what has changed. In one instance, the update message may include only the delta (e.g., only the change) between the original and the changed list of capabilities. In one instance, the update message may be transmitted in an RRC to the RAN node. When sending the update message, the WTRU may consider limiting, or adding, what the WTRU determines or is indicated as applicable to current or future connections (e.g., if a changed parameter(s) does not apply to a currently configured restricted set of bands, then the WTRU shall not provide that delta information).

The update message may indicate that the WTRU no longer supports a capability. For example, it may identify or list a capability that was previously sent and indicate that it should be removed from the WTRU capability information.

The update message may indicate that the WTRU supports a capability that it previously did not. For example, it may identify or list that a capability that was not previously sent and provide an indication that this capability should be added to the WTRU capability information.

The update message may include an indication that the message is to inform the RAN that the WTRU radio capabilities have been changed and need to be updated. Hence, the network (e.g., RAN, AMD, UCMF, etc.) may need to update the WTRU radio capability information and associated RACS ID(s).

In one instance, the WTRU may send the update message when WTRU radio capabilities are updated (e.g., via RRC, data plan, etc.).

In one instance, the WTRU may send the update message by initiating a registration procedure or service request procedure by sending a NAS message (e.g., registration request message, or service request message) to the AMF with registration type set to Mobility Registration Update (e.g., the NAS message may include the delta, changed full set of WTRU capabilities, indication of change, etc.).

The WTRU may include a WTRU radio capability ID/index (e.g., RACS ID) in the update message.

In one instance, the WTRU, during the initial registration, may limit the initial WTRU capability information only to a specific RAT, or to a specific subset of bands (e.g., lightweight radio capabilities only for the RAT (e.g., 6G) for which the WTRU is attempting the registration initially).

In one instance, the WTRU may limit update message only to a specific RAT, or to a specific subset of bands (e.g., lightweight radio capabilities only for the RAT (e.g., 6G) for which the WTRU is attempting the registration initially).

In one instance, each time the WTRU sends the WTRU radio capabilities (e.g., full or delta) to the network, the WTRU may generate an ID/index, or reference an existing ID/index it received from the UCMF, associated with the WTRU radio capability information that is in the message.

In one instance, the WTRU may receive an indication or flag from the RAN node, that the WTRU radio capability transfer via the data plane is enabled.

In one instance, the WTRU may send WTRU radio capability over the data plane to the NFs.

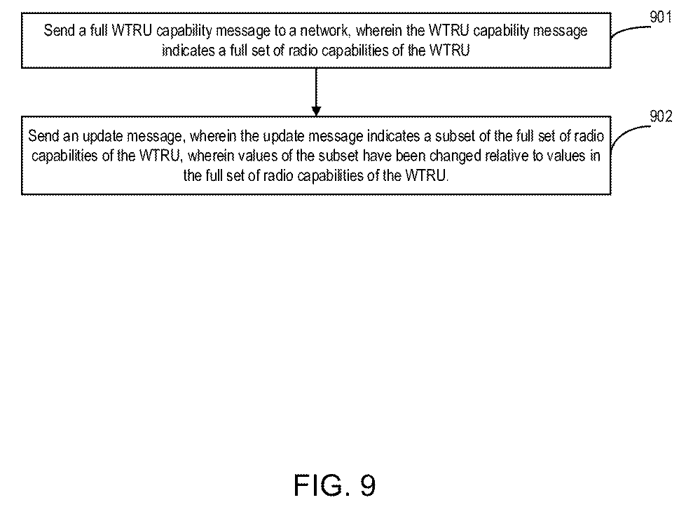

FIG. 9 illustrates an example of a WTRU sending radio capability information.

At 901, the WTRU may send a full WTRU capability message to the network, where full WTRU capability message indicates a full set of radio capabilities of the WTRU. At 902, the WTRU may send an update message, where the update message indicates a subset of the full set of radio capabilities of the WTRU, and where values of the subset have been changed relative to values in the full set of radio capabilities of the WTRU. In one instance, the update message includes an identifier (ID) or index, where the identifier (ID) or index is associated with the full set of radio capabilities of the WTRU that were indicated in the full WTRU capability message. In one instance, a registration message that includes a minimal set of radio capabilities is sent prior to sending the full WTRU capability message, wherein the minimal set of radio capabilities is determined based on a RAT of the WTRU, one or more frequency bands supported by a cell of the WTRU, one or more frequency bands supported by a PLMN of the WTRU, one or more frequency bands supported by a country where the WTRU is located, one or more frequency bands associated with carrier aggregation, one or more frequency bands associated with Dual Active Protocol Stack (DAPS), or one or more frequency bands associated with Conditional PSCell Addition/Change (CPAC). In one instance, the full set of radio capabilities of the WTRU includes all possible radio capabilities of the WTRU. In one instance, the full WTRU capability message includes an identifier (ID) or an index. In one instance, the update message includes an identifier (ID) or an index. In one instance, the update message is sent based on one or more WTRU capabilities from the full set of radio capabilities of the WTRU changing. In one instance, the update message is an RRC message. In one instance, the update message is a data plane message. In one instance, the WTRU receives an inquiry or request message prior to sending the full WTRU capability message or the update message. In one instance, the subset of the full set of radio capabilities of the WTRU is smaller than the full set of radio capabilities of the WTRU. In one instance, the full set of radio capabilities of the WTRU includes all radio capabilities that the WTRU can support. In one instance, the identifier (ID) or index associated with the full set of radio capabilities of the WTRU is preconfigured or received prior to sending the update message. In one instance, the WTRU receives a WTRU capability request message for the update message that prompts the sending of the update message. In one instance, the WTRU capability request message includes an indication that communication of the update message via the data plane or the user plane is enabled. In one instance, the update message is an RRC message. In one instance, the update message is sent based on one or more WTRU capabilities from the full set of radio capabilities of the WTRU changing. In one instance, the WTRU receives a WTRU capability request message prior to sending the full WTRU capability message or the update message. In one instance, the subset of the full set of radio capabilities of the WTRU is smaller than the full set of radio capabilities of the WTRU.

As described herein, a higher layer may refer to one or more layers in a protocol stack or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise one or more of the following: Non-Access Stratum (NAS), Internet Protocol (IP), and/or Radio Resource Control (RRC). For example, Layer 2 may comprise one or more of the following: Packet Data Convergence Control (PDCP), Radio Link Control (RLC), and/or Medium Access Control (MAC). For example, Layer 3 may comprise physical (PHY) layer type operations. The greater the number of the layer, the higher it is relative to other layers (e.g., Layer 3 is higher than Layer 1). In some cases, the aforementioned examples may be called layers/sublayers themselves, irrespective of layer number, and may be referred to as a higher layer as described herein. For example, from highest to lowest, a higher layer may refer to one or more of the following layers/sublayers: a NAS layer, an RRC layer, a PDCP layer, an RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein, there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where, for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something "does happen" or "can happen". In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where, for example, ‘A/B’ may represent ‘A and/or B’.

What is claimed:

1. A method performed by a wireless transmit/receive unit (WTRU), the method comprising:
sending a full WTRU capability message to a network, wherein the full WTRU capability message indicates a full set of radio capabilities of the WTRU; and
sending an update message, wherein the update message indicates a subset of the full set of radio capabilities of the WTRU, wherein values of the subset have been changed relative to values in the full set of radio capabilities of the WTRU, wherein the update message includes an identifier (ID) or index, wherein the identifier (ID) or index is associated with the full set of radio capabilities of the WTRU that were indicated in the full WTRU capability message.

2. The method of claim 1, wherein registration message that includes a minimal set of radio capabilities is sent prior to sending the full WTRU capability message, wherein the minimal set of radio capabilities is determined based on a radio access technology (RAT) of the WTRU, one or more frequency bands supported by a cell of the WTRU, one or more frequency bands supported by a PLMN of the WTRU, one or more frequency bands supported by a country where the WTRU is located, one or more frequency bands associated with carrier aggregation, one or more frequency bands associated with Dual Active Protocol Stack (DAPS), or one or more frequency bands associated with Conditional PSCell Addition/Change (CPAC).

3. The method of claim 1, wherein the full set of radio capabilities of the WTRU includes all radio capabilities that the WTRU can support.

4. The method of claim 1, wherein the identifier (ID) or index associated with the full set of radio capabilities of the WTRU is preconfigured or received prior to sending the update message.

5. The method of claim 1, wherein the WTRU receives a WTRU capability request message for the update message that prompts the sending of the update message.

6. The method of claim 5, wherein the WTRU capability request message includes an indication that communication of the update message via a data plane or a user plane is enabled.

7. The method of claim 1, wherein the update message is an RRC message.

8. The method of claim 1, wherein the update message is sent based on one or more WTRU capabilities from the full set of radio capabilities of the WTRU changing.

9. The method of claim 1, wherein the WTRU receives a WTRU capability request message prior to sending the full WTRU capability message or the update message.

10. The method of claim 1, wherein the subset of the full set of radio capabilities of the WTRU is smaller than the full set of radio capabilities of the WTRU.

11. A wireless transmit/receive unit (WTRU), the WTRU comprising:
a processor operatively coupled to a transceiver, wherein:
the processor and transceiver are configured to send a full WTRU capability message to a network, wherein the full WTRU capability message indicates a full set of radio capabilities of the WTRU;
the processor and transceiver are configured to sending an update message, wherein the update message indicates a subset of the full set of radio capabilities of the WTRU, wherein values of the subset have been changed relative to values in the full set of radio capabilities of the WTRU, wherein the update message includes an identifier (ID) or index, wherein the identifier (ID) or index is associated with the full set of radio capabilities of the WTRU that were indicated in the full WTRU capability message.

12. The WTRU of claim 11, wherein registration message that includes a minimal set of radio capabilities is sent prior to sending the full WTRU capability message, wherein the minimal set of radio capabilities is determined based on a radio access technology (RAT) of the WTRU, one or more frequency bands supported by a cell of the WTRU, one or more frequency bands supported by a PLMN of the WTRU, one or more frequency bands supported by a country where the WTRU is located, one or more frequency bands associated with carrier aggregation, one or more frequency bands associated with Dual Active Protocol Stack (DAPS), or one or more frequency bands associated with Conditional PSCell Addition/Change (CPAC).

13. The WTRU of claim 11, wherein the full set of radio capabilities of the WTRU includes all radio capabilities that the WTRU can support.

14. The WTRU of claim 11, wherein the identifier (ID) or index associated with the full set of radio capabilities of the WTRU is preconfigured or received prior to sending the update message.

15. The WTRU of claim 11, wherein the WTRU receives a WTRU capability request message for the update message that prompts the sending of the update message.

16. The WTRU of claim 12, wherein the WTRU capability request message includes an indication that communication of the update message via a data plane or a user plane is enabled.

17. The WTRU of claim 11, wherein the update message is an RRC message.

18. The WTRU of claim 11, wherein the update message is sent based on one or more WTRU capabilities from the full set of radio capabilities of the WTRU changing.

19. The WTRU of claim 11, wherein the WTRU receives a WTRU capability request message prior to sending the full WTRU capability message or the update message.

20. The WTRU of claim 11, wherein the subset of the full set of radio capabilities of the WTRU is smaller than the full set of radio capabilities of the WTRU.
